(19) United States
(12) Patent Application Publication
(10) Pub. No.: US 2019/0233734 A1
(43) Pub. Date: Aug. 1, 2019

(54) Micro-scale process for the direct production of liquid fuels from gaseous hydrocarbon resources

(71) Applicant: Greyrock Energy, Inc., Sacramento, CA (US)

(72) Inventors: Robert Schuetzle, Sacramento, CA (US); Dennis Schuetzle, Grass Valley, CA (US)

(21) Appl. No.: 15/932,037

(22) Filed: Jan. 26, 2018

(51) Int. Cl. C10G 2/00; C01B 3/38

(52) U.S. Cl. CPC C10G 2/32; C01B 3/38; C01B 2203/1247; C01B 2203/062; C01B 2203/0233

(57) ABSTRACT

An easily transportable micro-scale process is described for the direct production of liquid fuels from flare gas, biogas, stranded natural gas, natural gas emissions from methane hydrate dissociation, and other low-volume, gas-phase hydrocarbon resources. The process involves the design of an integrated series of tubular catalytic reactors in which each consecutive catalytic reactor in the series has been designed with larger volumes of catalyst so that a single pass efficiency of about 90% or greater is achieved while keeping the temperatures and pressures of each reactor similar and without requiring tailgas recycling to the reactors. Typically, the process employs a direct fuel production catalyst that produces undetectable, detrimental carboxylic acids in the fuel and catalyst reaction water. As a result, the directly produced, premium fuels are non-corrosive and do not degrade during long-term storage.

### FIELD OF THE INVENTION

This invention relates to a transportable, micro-scale process for the direct, economical production of premium liquid fuels from low-volume, gas-phase hydrocarbon resources.

### BACKGROUND OF THE INVENTION

Gas to Liquid (GTL) technologies for converting natural gas to liquid fuels have existed for several decades. A recent resurgence of interest in converting flared gas, biogas, natural gas, and other low volume gas-phase hydrocarbon resources to liquid fuels is providing significant advancements in the rapidly growing GTL art. These advancements are motivated by the need to eliminate and simplify costly unit processes typically employed by current medium and large-scale GTL plants.

Medium-scale and large-scale plants typically convert approximately 25-250 million scf per day, and more than 250 million scf per day of gas-phase hydrocarbons to fuels and other products, respectively. These medium and large plants all employ four major processes (A. de Klerk, 2012). These processes include: 1) syngas generation; 2) syngas purification; 3) catalytic conversion of the syngas to hydrocarbon products, the primary product being wax; and 4) conversion of the wax to fuels using complex and costly refinery type processes.

In addition to wax, these plants produce side products consisting of tail-gas, liquid hydrocarbons and catalyst reaction water. The composition and concentration of these side products are dependent upon the syngas composition and purity; catalytic reactor design; catalyst formulation and catalyst operating conditions.

Syngas can be produced from many types of carbonaceous resources, including natural gas, coal, biomass, or virtually any carbon containing feedstock using thermochemical conversion processes. These thermochemical conversion processes are typically categorized as processes that 1) utilize oxygen or air or 2) processes that do not employ oxygen or air.

Syngas generation processes that utilize oxygen or air are typically referred to as direct conversion, partial oxidation (POX), or Autothermal Reforming (ATR) processes. POX is carried out with sub-stoichiometric gaseous hydrocarbon/oxygen mixtures in reformers at temperatures in the 1,500-2,700° F. range. Praxair, Shell, ConocoPhillips and others have developed systems for the conversion of gaseous hydrocarbon resources into syngas using POX. Each of these systems uses an oxygen input, requiring pressurized oxygen to be delivered to the plant using one of the methods described above. As an example, the Praxair process utilizes a hot oxygen burner that is non-catalytic and converts natural gas (or other hydrocarbons) and oxygen into syngas as described in U.S. Pat. No. 8,727,767 (May 2014).

The conversion of solid-phase and liquid-phase carbonaceous feedstocks, using steam in the absence of oxygen or air, is typically referred to as indirect thermochemical conversion. Steam methane reforming (SMR) is a well-established method for the conversion of gas-phase hydrocarbons to syngas. Since methane is difficult to efficiently steam reform to syngas at temperatures below about 2,200° F., catalysts are typically employed to reduce the reforming temperature to about 1,600-1,700° F. This process is referred to as catalytic steam reforming and is very efficient for the reforming of other gas-phase hydrocarbons such as C₂-C₁₆ hydrocarbons, C₁-C₁₆ hydroxy-alkanes and C₃-C₁₆ ketones (Sa et al., 2010).

Table 1 summarizes some potential catalyst contaminants in syngas and their maximum recommended contaminant levels. Numerous methods are available in the current art for the removal of hydrogen sulfide, sulfur dioxide, ammonia, hydrogen cyanide, nitrogen oxides, hydrogen chloride and particulates in syngas.

TABLE 1
Potential Catalyst Contaminants in Syngas and Their
Maximum Recommended Contaminant Levels for the
Conversion of Syngas to Hydrocarbon Products

| Catalyst | Maximum Recommended | |
|---|---|---|
| Contaminants | Contaminant Levels | |
| Hydrogen Sulfide (H₂S) | <20 | ppb |
| Sulfur Dioxide (SO₂) | <200 | ppb |
| Ammonia (NH₃) | <5 | ppm |
| Hydrogen Cyanide (HCN) | <20 | ppb |
| Nitrogen Oxides (NOx) | <200 | ppb |
| Hydrogen Chloride (HCl) | <35 | ppb |
| Oxygen (O₂) | <500 | ppb |
| Total Particulate Matter (PM_{2.5}) | <500 | μg/m³ |

Deleterious carboxylic acids can be formed by the reaction of oxygen with free radical species during the catalytic conversion of the syngas with CO and H₂. If carboxylic acids are formed, they will be approximately distributed between the liquid fuel, catalyst reaction water and wax as summarized in Table 2. When these carboxylic acids are present in fuels, the fuel can corrode metal surfaces and fuel storage lifetime is reduced considerably. Therefore, these acids need to be removed (if present) from the fuel before distribution, storage and use which is challenging and costly.

Concurrently, when these carboxylic acids are present in the catalyst reaction water, they need to be removed before the water can be recycled and used for plant processes. In addition to the problem of metal surface corrosion, these acids can damage the catalysts typically used in catalytic steam reforming processes.

TABLE 2
The Relative Distribution of Carboxylic Acids (if formed)
in the Catalyst Reaction Water, Liquid Fuels and Wax

| | | Relative Distribution (mole %) | | |
|---|---|---|---|---|
| | | | Liquid | |
| Carboxylic Acid | BP (° C.) | Water | Fuels | Wax |
| Methanoic (formic) | 101 | 100 | 0 | 0 |
| Ethanoic (acetic) | 118 | 100 | 0 | 0 |
| Propanoic | 141 | 75 | 25 | 0 |
| Butanoic | 164 | 30 | 70 | 0 |
| Pentaonic | 187 | 10 | 85 | 5 |
| Hexanoic | 205 | 5 | 80 | 15 |
| Octanoic | 239 | <1 | 75 | 25 |

Many techniques are available in the current art for the purification of syngas before catalytic conversion of the syngas to hydrocarbon products. The thermochemical conversion of gas-phase hydrocarbons produces much lower concentrations of syngas contaminants than the conversion of solid carbonaceous materials such as biomass, coal, municipal solid waste, and other solids. Sulfur compounds are the most prevalent contaminants in many gas-phase hydrocarbon resources. These contaminants can be readily removed using a variety of solid-phase binding agents, such as iron oxide or zinc oxide.

The two primary approaches for the catalytic conversion of syngas to fuels are: 1) catalytic conversion of the syngas to intermediate products (primarily wax), followed by costly wax upgrading and refining processes such as hydrocracking and; 2) direct catalytic conversion of the syngas to fuels that produce minimal wax [U.S. Pat. No. 8,394,862 (August 2013) and U.S. Pat. No. 9,090,831 (July 2015)].

All of the current medium and large-scale GTL plants convert syngas to wax as the primary product. Refining/upgrading processes are then employed to produce fuels and other products from the wax. Since these refining processes are complex and expensive, fuel production costs can be increased by about 40% or more versus direct fuel production approaches. Medium and large plant designs incorporating traditional F-T processes, that utilize wax hydrocracking and other expensive upgrading processes, are not economically viable for distributed plants that process relatively low volumes of gas-phase hydrocarbons.

Micro-GTL plants encompass processes that convert about 0.05-2.5 million scf/day of gas-phase hydrocarbons into about 5-250 barrels/day of liquid fuels. GTL plants that convert about 2.5-50 million scf/day of gas-phase hydrocarbons into about 250-5,000 barrels/day of fuel, are typically referred to as small-GTL plants.

There are several types of catalytic reactors that have been deployed commercially for the catalytic conversion of syngas to hydrocarbon products. Multi-tubular, fixed-bed catalytic reactors are comprised of many small diameter tubes that are used to contain catalysts. These tubes are enclosed inside a reactor shell in which water is circulated to remove the exothermic heat produced from the conversion of syngas to hydrocarbon products. The use of catalysts that produce heavy waxes may coat the catalyst resulting in reduction in catalyst activity. These reactors are operated in a multi-pass mode with removal of the products after each pass and recycling of the unreacted syngas back to the catalytic reactors. Two to three passes through these reactors typically converts about 90 volume % of the CO to hydrocarbon products.

Slurry reactors employ finely-divided catalysts suspended in a liquid medium. Heat removal is carried out using internal cooling coils. The synthesis gas is bubbled through the liquid medium which also provides agitation of the reactor contents. The small catalyst particle size improves mass transfer of heat to the liquid medium. Wax products must be separated from the catalyst particles.

Micro-channel reactors consist of reactor cores that contain thousands of thin process channels that are filled with very small particle size catalysts. These reactor cores are interleaved with 0.1-10 mm channels that contain water coolant. Since the catalyst particles and channels are small, heat may be dissipated more quickly than the traditional 25-40 mm tubular reactors.

Many catalysts and catalytic processes have been developed and deployed for the conversion of syngas to wax. These catalysts are typically referred to as Fischer-Tropsch (F-T) catalysts (Jahangiri et al., 2014). Reported processes describe catalysts that produce high molecular weight hydrocarbon reaction products (e.g., wax) which require further processing, including hydro-processing and other upgrading processes, to produce diesel fuel or diesel blendstock.

The product stream from the catalytic reactors is generally separated into the following fractions: tail gas; condensed liquid hydrocarbons, catalyst reaction water and waxes using a two or three-phase separator. The tail gas fraction is typically comprised of H₂, CO, CO₂, C₁-C₅ hydrocarbons, and oxygenated organic compounds; the condensed fraction comprises C₅-C₂₄ hydrocarbons and oxygenated organic compounds; the wax fraction comprises C₂₃-C₁₀₀₊ hydrocarbons; and the catalyst reaction water fraction is comprised of water with up to about 5.0 volume % of dissolved oxygenated organic compounds.

Since the catalytic conversion efficiency of syngas is typically about 90% or higher when using tubular reactors with tail-gas recycling, some H₂ and CO will remain in the tailgas. In addition, the tail-gas contains some CH₄ which is produced from the catalytic reaction. The composition of the tail-gas is dependent upon the type of thermochemical process, the catalyst used and operating conditions. This tail-gas can be recycled back to the thermochemical conversion system to produce additional syngas and/or it can be used as burner fuel. Virtually all reported catalytic processes have been used to convert syngas primarily to wax.

### SUMMARY OF THE INVENTION

The advantages of this micro-scale GTL process are summarized below. Only three, primary modular processes are required including the: 1) syngas purification and syngas generator unit; 2) catalytic reactors and product separation/collection unit; and 3) a facility services unit that includes recycle pumps, process control systems and utilities. This micro-scale GTL plant can economically and efficiently convert from about 0.05-2.5 million scf/day, and even lower gas volumes of 0.00-0.05 million scf/day and higher gas volumes of about 2.5 million scf/day to 10 million scf/day of gas-phase hydrocarbons directly to premium liquid fuels.

The catalytic reactor is operated at moderate temperatures of 350-450° F., preferably 400-425° F. and gas hourly space velocities of 100-10,000, preferably 1000-2,500. Since this reactor employs high efficiency steam cooling to rapidly remove heat from the exothermic catalyst reaction, greater than about 70 mole %, preferably greater than about 80 mole % or more preferably greater than 90 mole %, conversion of H₂ and CO to products is achieved in a single pass through the multiple catalytic reactors linked in series. This reduces or eliminates costly re-compression and recycling of the catalyst tail-gas back to the catalytic reactors. The catalyst tailgas is recycled back to the syngas generation step to produce additional syngas, is used as burner fuel, is used to generate power, or various combinations of these recycle processes.

The catalyst produces very little wax (<25 volume %, preferably <5 volume % and more preferably <2 volume % at an average H₂/CO ratio of 2.06) and this wax remains as a liquid in the catalytic reactor at the operation temperatures of 400-425° F. since it is a light wax consisting of predominantly C₂₂-C₃₅ hydrocarbons. This liquefied wax flows through the catalytic reactors and is either removed from the bottom of the reactors or separated into a drum without obstructing the flow of syngas. Since very little wax is produced, complex and costly refining processes are not needed for the conversion of wax to fuels.

In one case, the operating conditions of the catalytic reactor may be changed (which may include the H₂:CO ratio, gas hourly space velocity, pressure, or temperature) and based on the specific operating conditions the resulting hydrocarbon distribution of the fuel product is changed in order to optimize the fuel products for sale in specific markets. For example, by lowering the H₂:CO ratio below 2.0:1.0 the product output will shift the hydrocarbon distribution to a higher molecular weight that may be desirable in some market areas and applications. Conversley, the H₂:CO ratio can be increased above 2.0:1.0 to shift the hydrocarbon distribution to a lower molecular weight.

Since the catalyst reaction water contains undetectable levels of corrosive and detrimental carboxylic acids that are below about 100 ppm, or preferably less than 25 ppm or more preferably less than 15 ppm, the catalyst water can usually be directly recycled and used in the steam reformer. As a result, little or no external water is required for the operation of the plant. The premium fuel is comprised of C₅-C₂₄ hydrocarbons which can be used directly in off-road diesel engines, blended at about 20 volume % with traditional petroleum diesel, or easily distilled into various fuel products, depending upon local market requirements.

### BRIEF DESCRIPTION OF THE FIGURES

FIG. 1 illustrates the primary processes for the micro-scale GTL system.

FIG. 2 provides details for the catalytic reactor 1 which comprises the direct fuel production catalyst.

FIG. 3 illustrates the types of fuel products from the distillation of the liquid fuels generated directly from the micro-scale GTL system.

### DETAILED DESCRIPTION OF THE INVENTION

A first aspect of the micro-scale process of the present invention is the incorporation of a direct fuel production catalyst 109b that has been formulated to directly produce premium liquid fuels and catalyst reaction water that contains undetectable or barely detectable deleterious carboxylic acids. In this context, undetectable is defined as values that are at or below the detection limit in which the detection limit is the lowest concentration that can be reliably distinguished but is below the level which is quantifiable with acceptable precision. The quantitation limit is the lowest concentration which can not only be detected, but also quantified with a specific degree of precision. The quantitation limit is always greater than the detection limit, usually by a factor of three or four. For example, the detection limit of the GC/MS technique used to quantify the oxygenated hydrocarbons listed in Table 4 was 25 ppm and the quantitation limit was 75-100 ppm. Barely detectable is defined as values between the detection limit and the quantitation limit. Therefore undetectable or barely detectable is defined as <25-100 ppm.

When the direct fuel production catalyst described in U.S. Pat. No. 8,394,862 (August 2013) and U.S. Pat. No. 9,090,831 (July 2015) is manufactured using a substrate that has close to a neutral surface pH (e.g., a pH of about 7.0) and when the oxygen concentration in the syngas is less than 5,000 ppm, preferably less than 1,000 ppm, and more preferably less than 500 ppm, specific carboxylic acids are not detected above about 100 ppm, and preferably not above about 25 ppm, and more preferably not above about 15 ppm in the catalyst reaction water and liquid fuel fractions.

Catalyst characteristics include: The catalyst shape is ideally an extrudate with a lobed, fluted, or vaned cross section but could also be a sphere, granule, powder, or other support shape that allows for efficient operation. The use of a lobed structure, for example, enables a significant increase in the ratio of area to volume in the catalytic reactor, thus improving the volumetric efficiency of a catalytic reactor system. The lobed structures also provide an improved pressure drop, which translates into a lower difference in the pressure upstream and downstream of the catalyst bed, especially when they are used in fixed bed reactors.

The effective pellet radius of a catalyst pellet or support refers to the maximum radius which is a distance from the mid-point of the support to the surface of the support. For lobed supports, the effective pellet radius refers to the minimum distance between the mid-point and the outer surface portion of the pellet. In certain cases, the effective pellet radius is about 600 microns or less. In other cases, the effective pellet radius is about 300 microns or less.

The catalyst pellet or support material may be porous. In certain cases, the mean surface pore diameter, of the support material is greater than about 100 angstroms. In other cases, it is greater than about 80 angstroms.

Any suitable material that can have a neutral surface (e.g., a pH of about 7.0) can be used as a support material for the catalyst in the Fischer-Tropsch process. Nonlimiting examples of supports include metal oxides such as alumina, silica, zirconia, magnesium or combinations of the metal oxides. Alumina is oftentimes used as the support.

The catalytically active metals, which are included with or dispersed to the support material, include substances which promote the production of diesel fuel in the catalytic reaction. For example, these metals include cobalt, iron, nickel, or any combinations thereof. Various promoters may be also added to the support material. Examples of promoters include cerium, ruthenium, lanthanum, platinum, rhenium, gold, nickel and rhodium.

In certain cases, the catalyst support has a crush strength of between about 1 lb./mm and about 10 lbs./mm and a BET surface area of greater than about 75 m²/g. In other cases, the catalyst has a crush strength between about 2 lbs./mm and about 5 lbs./mm and a BET surface area of greater than about 100 m²/g. In still other cases, the catalyst has a crush strength between about 3 lbs./mm and 4 lbs./mm. In still other cases the catalyst has a BET surface area of greater than about 125 m²/g, or 150 m²/g.

The active metal distribution on the support is typically between about 2% and about 10%. Oftentimes the active metal distribution is between about 3% and about 5% (e.g., about 4%). The active metal distribution is the fraction of the atoms on the catalyst surface that are exposed as expressed by: D=N_{S}/N_{T}, where D is the dispersion, NS is the number of surface atoms, and NT is the total number of atoms of the material. Dispersion increases with decreasing crystallite size.

In certain cases, a supported catalyst includes cobalt, iron, nickel, or combinations thereof, deposited at between about 5 weight % and 30 weight % on gamma alumina having a neutral surface, more typically about 20 weight % on gamma alumina having a neutral surface, based on the total weight of the supported catalyst. Also in these cases, the supported catalyst formulation includes selected combinations of one or more promoters consisting of ruthenium, palladium, platinum, gold, nickel, rhenium, and combinations thereof in about 0.01-20.0 weight % range, more typically in about 0.1-0.5 weight % range per promoter. Production methods of the catalyst include impregnation and other methods of production commonly used in the industry and are described in the art.

Liquid fuels produced directly using a catalyst according to the present invention have very little or no corrosive properties and exhibit very little or no oxidation or degradation during storage, and can be stored for years without change. Furthermore, the catalyst reaction water can usually be directly recycled 112 to the syngas generator 103.

When the catalyst according to the present invention is used to convert syngas directly to fuels, the catalyst reaction water contains very little or non detectable levels of carboxylic acids. Table 4 summarizes data for hydroxy-alkanes (e.g. alcohols) and carboxylic acids in catalyst reaction water produced from the catalysis of syngas that was generated by the steam reforming of natural gas, natural gas liquids and glycerol using the catalyst of the present invention. Although the total concentration of hydroxy-alkanes was found to be 12,831 ppm, 16,560 ppm and 18,877 ppm, respectively, for syngas generated from these three feedstocks, acetic acid, propionic acid and malonic acid were undetectable (less than about 25 ppm each) in the catalyst reaction water samples.

Since the hydroxy-alkanes and carboxylic acids will be distributed between the catalyst reaction water and fuels, the possible presence of carboxylic acids in the liquid fuels can be easily be estimated by employing the ASTM D130 copper strip corrosion test. If carboxylic acids are present then the surface of the copper strip changes color in which a designation of 1a indicates very little or no corrosion to 4c for which the fuel corrodes the copper strip to a dark brown/black color establishing that the fuel contains unacceptable levels of carboxylic acids (ASTM International, 2012). It was determined that the fuels produced directly from these feedstocks provided a 1a test result which confirmed that carboxylic acids were undetectable.

TABLE 4
The Concentration of Oxygenated Organic Compounds in Catalyst
Reaction Water produced from Syngas derived from Various Gas-
Phase Hydrocarbons using the Direct Fuel Production Catalyst

| | Gas-Phase Hydrocarbon Resource | | |
|---|---|---|---|
| | | Vaporized | |
| Oxygenated | | Natural Gas | Vaporized |
| Organic | Natural Gas | Liquids | Glycerol |
| Compound | Concentration (ppm) in Catalyst Reaction Water¹ | | |
| Methanol | 4470 | 4980 | 6177 |
| Ethanol | 4890 | 5040 | 6529 |
| 1-Propanol | 1970 | 1930 | 2209 |
| 1-Butanol | 1980 | 2530 | 1888 |
| 1-Pentanol | 1080 | 1380 | 1342 |
| 1-Hexanol | 310 | 290 | 333 |
| 1-Heptanol | 111 | 60 | 67 |
| 1-Octanol | <25 | <25 | 122 |
| 1-Nonanol | <25 | <25 | <25 |
| Acetic Acid | <25 | <25 | <25 |
| Propionic Acid | <25 | <25 | <25 |
| Malonic Acid | <25 | <25 | <25 |
| Total | 12,831 | 16,560 | 18,877 |

¹Undetectable is defined as values that are at or below the detection limit of 25 ppm in which the detection limit is the lowest concentration that can be reliably distinguished but is below the level which is quantifiable with acceptable precision.

A second aspect of the micro-scale process of the present invention is the direct recycling of the catalyst reaction water, since it contains undetectable or barely detectable, detrimental carboxylic acids. If the syngas production processes do not require much steam, such as for a reciprocating engine syngas reformer, this catalyst reaction water may be used for the recovery of additional oil from a co-located oil well.

When oil is present in subterranean rock formations such as sandstone, carbonate, or shale, the oil can generally be exploited by drilling a borehole into the oil-bearing formation and allowing existing pressure gradients to force the oil up the borehole. This process is known as primary recovery. If and when the pressure gradients are insufficient to produce oil at the desired rate, it is customary to carry out an improved recovery method to recover additional oil. This process is known as secondary recovery.

Even after secondary recovery using water injection, large quantities of the original oil remain in place. The fraction of unrecoverable hydrocarbon is typically highest for heavy oils, tar, and complex geological formations. In large oil fields, more than a billion barrels of oil may be left after conventional water injection.

Tertiary recovery then becomes the focus. It is estimated that current tertiary oil recovery techniques have the ability to remove an additional 5 to 20 percent of oil remaining in a reservoir. The development of effective tertiary oil recovery strategies for higher oil recovery promises to have a significant economic impact. Current methods of tertiary recover are effective, but expensive since many oil producing locations have limited supplies of water.

It has been found that hydroxy-alkanes (alcohols), comprised of one to four carbons dissolved in water, are ideal for tertiary oil recovery [U.S. Pat. No. 7,559,372 (July 2009)]. However, the addition of mixed alcohols to water for tertiary oil recovery is very costly. Since this catalyst reaction water, produced from the catalyst described in this document, contains up to about 2.0 volume % of C₁-C₅ alcohols, it is ideal for direct use in tertiary oil recovery.

Micro-scale GTL systems typically denote plants that convert less than about 2.5 million scf per day (MMScf/day) of gas-phase hydrocarbons to liquid hydrocarbon products. The medium and large scale GTL systems cannot be economically scaled down to process less than about 2.5 million scf per day of gas-phase hydrocarbons without the elimination of major unit processes and the simplification of other processes.

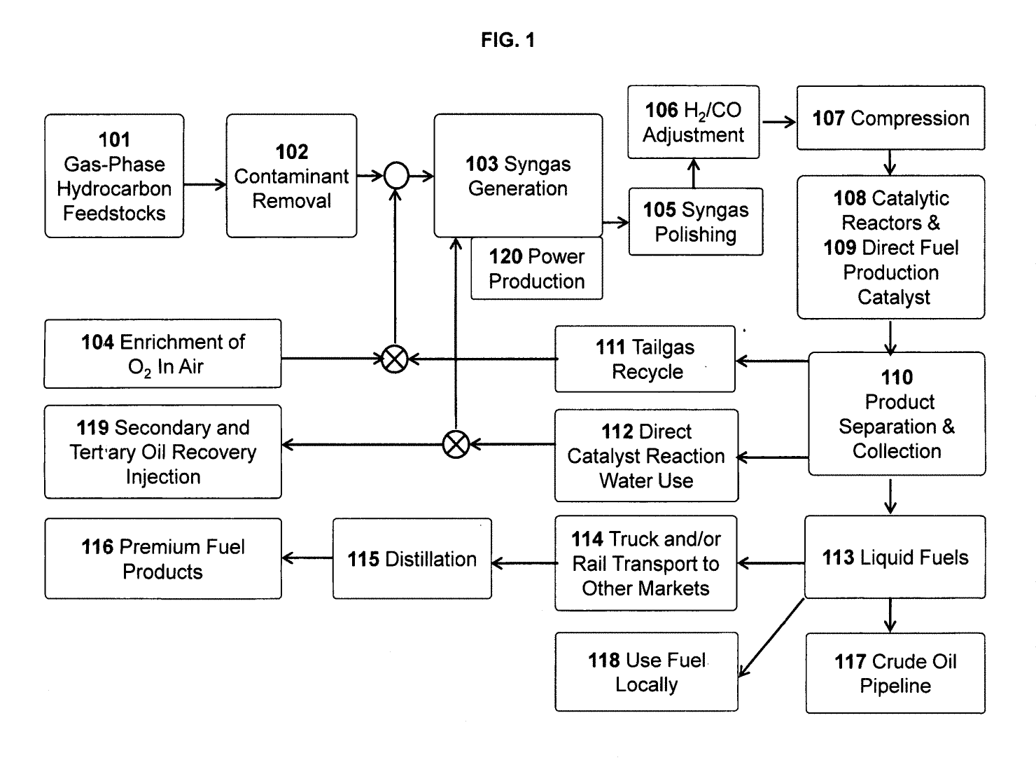

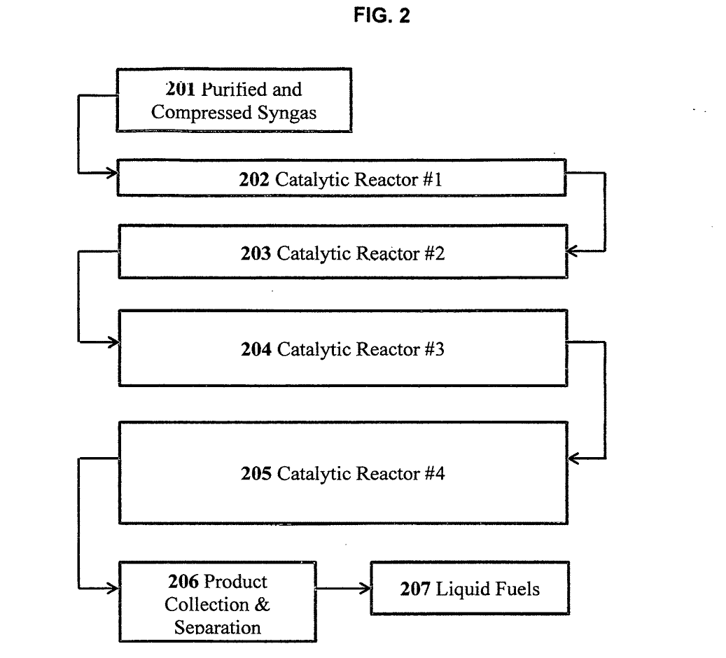

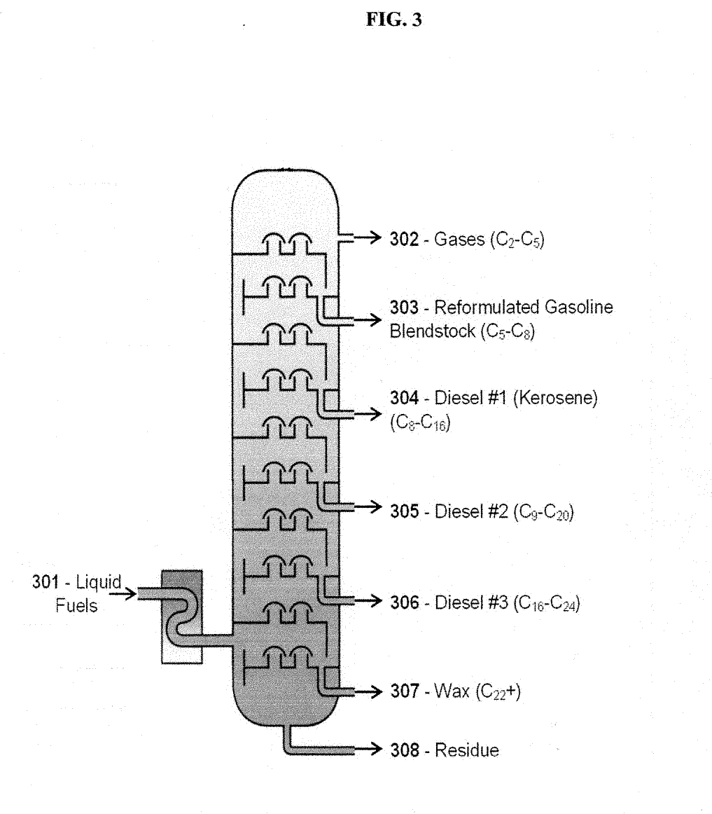

FIG. 1 illustrates aspects of the unit processes for micro-scale GTL process of the present invention. The process involves: a series of catalytic reactors 108 (FIG. 2) that eliminate or reduce the need for tailgas re-compression and recycling; a direct fuel production catalyst 109 that produces undetectable levels of individual carboxylic acids below about ≤100 ppm, or preferably less than 25 ppm, or more preferably less than 15 ppm in the liquid fuel and catalyst reaction water; a process for the direct recycling of the catalyst reaction water 112 for use as steam in the syngas generator 103 and/or for use in tertiary oil recovery 119; the introduction of the liquid fuel directly into a crude oil pipeline 117; the direct use of the fuel locally for off-road diesel engines used in generators, compressors, pumps, tractors, etc. 118; or the transport of the liquid fuels to another location for the production of premium liquid fuel products 116 (FIG. 3) that meet or exceed ASTM and/or other equivalent fuel standards.

FIG. 3 provides design details for the catalytic reactor from unit process 108 (FIG. 2) which consist of a series of four reactors 202-205 connected in series for the efficient single-pass, direct conversion of the purified and compress syngas 201 into premium fuels 207.

The process of the present invention results in the elimination of several, unnecessary unit processes and the simplification of other processes resulting in significantly lower capital, operating costs, system mobility and operating simplicity for the micro-scale, direct production of liquid fuels from gas-phase hydrocarbon resources.

The following descriptions are presented to enable any person skilled in the art to make and use the invention, and are provided in the context of a particular application and its requirements. Various revisions to the disclosed embodiments will be readily apparent to those skilled in the art, and the general principles defined herein may be applied to other embodiments and applications without departing from the spirit and scope of the present invention. Thus, the present invention is not limited to the embodiment shown, but is to be accorded the widest scope consistent with the principles and features disclosed herein.

The term “comprises” and grammatical equivalents thereof are used herein to mean that other components, ingredients, steps, etc., are optionally present. For example, an output comprising components A, B and C can contain only components A, B and C, or can contain not only components A, B and C but also one or more other components.

FIG. 1 represents the primary unit processes for an embodiment of the invention. Gas-phase hydrocarbon and/or vaporized liquid hydrocarbon resources are input into the system 101. These resources may be natural gas; bio-gas; associated gas; gas phase hydrocarbons (for example C₂-C₄); Y-grade mix, or natural gas liquids (NGL) mix; individual components extracted from natural gas streams such as ethane, propane, butane, or others, natural gas condensates (C₅₊); or other similar gases or liquids (such as naphtha or condensate) that can be easily vaporized into a gas. Any adverse contaminants, such as sulfur compounds, are removed 102 from the gas-phase hydrocarbons before input to the syngas generator 103.

The first syngas generator 103 utilizes steam to facilitate conversion of the hydrocarbons to syngas. The steam is produced primarily from the direct recycling and use of the catalyst reaction water 112 and in some cases make-up water may be needed to adjust the steam to carbon ratio to eliminate the formation of elemental carbon. Syngas generator 103 employs a catalyst which converts methane and other hydrocarbons efficiently to syngas at operating temperatures below about 1,700° F. A syngas polishing unit 105 may be used to remove any syngas contaminants that may still be present. Since the catalytic steam reforming process may produce a H₂/CO ratio that is too high, a membrane system 106 is employed to adjust this ratio to about 2.2. Compression 107 may be needed to increase the syngas pressure to about 350 psi.

An alternative syngas generator 103 may be employed that utilizes a modified reciprocating engine to produce syngas [U.S. Patent Publication 2014/0144397 (May 2014)]. A membrane separator (Lin et al., 2013) or vapor pressure swing adsorption (VPSA) [Praxair, 2016] system 104 is used to enrich the O₂ in air from about 30% to 93%, respectively, for input with the gas-phase hydrocarbons to the reciprocating engine syngas generator 103.

Syngas contaminants that may be formed by the reciprocating engine reformer syngas generator 103, such as ammonia, HCN and particulates, are removed using processes commonly employed in the art 105. Since the H₂/CO ratio is in the nearly ideal range of 1.6-2.0, adjustment of this ratio 106 is not necessary. Compression 107 may be needed to increase the syngas pressure to about 350 psi.

FIG. 2 provides design details for the catalytic reactor 200 which consists of a series of several reactors 202-205 connected in series for the efficient single-pass, direct conversion of the syngas into premium fuels (FIG. 2 illustrates 4 reactors in series). This configuration eliminates the need for tailgas re-compression and recycling which is typically employed in the existing art. The series of several horizontal or vertical catalytic reactors or reactors at an angle between horizontal and vertical 200 is designed to efficiently convert about 70 mole %, preferably 80 mole %, or more preferably 90 mole % of H₂ and CO in the syngas to products without re-compression and recycling of the syngas. In preferred embodiments, two to five reactors (e.g., 2 reactors, 3 reactors, 4 reactors or 5 reactors) are used or six to ten reactors (e.g., 6 reactors, 7 reactors, 8 reactors, 9 reactors or ten reactors) are used to achieve the desired results.

These multi-tubular catalytic reactors 202-205 efficiently remove heat from the exothermic, catalytic reaction. They are operated at temperatures of about 350° F. to 450° F., but preferably 400 to 430° F.; at pressures of about 250 to 450 psig; and gas space velocities of about 100 to 10,000 hr-1, but preferably 500 to 3,000 hr-1.

The purified syngas 201 (FIG. 2) is input to catalytic reactor 1202, which is operated at temperatures, pressures and space velocities that are needed to convert about 35% of the CO and H₂ being converted to products. The remaining CO and H₂ and products from catalytic reactor 1 202 are input to the extended catalytic reactor 2 203 which is operated at temperatures, pressures and space velocities that are required to convert about 50% of the remaining CO and H₂ to additional products.

The remaining CO and H₂ and products from catalytic reactor 2 203 are input to the yet longer catalytic reactor 3 204 which is operated at the required temperatures, pressures and space velocities for conversion of about 65% of the remaining CO and H₂ to additional products. However in some embodiments, the reactors can have differing tube counts, or in other embodiments they have the same size and/or have the same tube count. The unique arrangement and design of these catalytic reactors provides about a 90% or greater conversion efficiency of the CO and H₂ to liquid fuels without the requirement for separation of the liquid fuels and catalyst reaction water from the catalyst tail gas and re-compression and recycling of the products as typically employed in the current art.

The direct fuel production catalyst 109 is formulated as described by Schuetzle in U.S. Pat. No. 9,090,831 (July 2015), except that a catalyst substrate is utilized that has nearly neutral surface properties (defined as a surface that is neither acidic nor basic).

When a catalyst substrate is utilized that is neither surface acidic or surface basic, undetectable detrimental carboxylic acids are produced in the fuel and catalyst reaction water. As a result the liquid fuels produced directly are non-corrosive or have very little or no corrosive properties, exhibit very little or no oxidation or degradation during storage, and can be stored for years without change. Furthermore, the catalyst reaction water can be generally, directly recycled 112 to the syngas generator, such as a steam reformer, 103 without any problems.

In certain cases where the syngas generator requires little or no steam, such as the reciprocating engine syngas generator, the catalyst reaction water can be injected into oil wells for secondary and tertiary oil recovery 119.

The liquid fuels are separated using a three-phase separator 110 into tailgas 111 (C₁-C₄ hydrocarbons, oxygenated hydrocarbons, CO₂, and unreacted H₂ and CO), catalyst reaction water 112, and liquid fuels 113 (primarily consisting of C₅-C₂₄ hydrocarbons and oxygenated organic compounds). A small quantity of wax is also produced (primarily consisting of C₂₄-C₄₀ hydrocarbons). One embodiment of the invention will produce less than 25 weight % wax by weight of its total product output and; a preferred embodiment will produce less than 5 weight % wax, and a more preferred embodiment will produce less than 2 weight % wax.

In some embodiments of the invention, the operating conditions of the catalytic reactor may be changed to alter the resulting product slate to optimize economics for a specific market application. Operating conditions in the catalytic reactor that influence the output product slate include H₂:CO ratio, gas hourly space velocity, pressure, and/or temperature. For example, by lowering the H₂:CO below 2.0:1 the product output will shift to a heavier hydrocarbon distribution that may be desirable in some market areas and applications. In some embodiments of the invention, the tailgas 111 may be recycled to the thermochemical syngas generator 103 where it can be converted into additional syngas or used as burner fuel.

An optional aspect of the present invention is the direct recycling of the catalyst reaction water 112 to the steam reformer or if a syngas generator is used which require little or no steam, the catalyst reaction water can be used directly for tertiary oil recovery. This innovation is made possible since the catalyst reaction water contains undetectable or barely detectable levels of the deleterious carboxylic acids.

The liquid fuel 113 can be used directly and locally in off-road engines used in diesel generators, tractors, compressors, water pumps, farm equipment, construction equipment, etc.

The liquid fuel 113 can be collected and transported by truck and/or rail to a central location where it is distilled 115 into the premium fuel products 116 illustrated in FIG. 3 for distribution to local fuel markets.

The possible products from the distillation of the liquid fuel FIG. 3 include: reformulated gasoline blendstocks (approximately C₅-C₈ hydrocarbons & oxygenated organic compounds) 303; diesel #1 (kerosene) (approximately C₈-C₁₆ hydrocarbons & oxygenated organic compounds) 304; diesel #2 305 (approximately C₉-C₂₀ hydrocarbons & oxygenated organic compounds); diesel #3 306 (approximately C₁₆-C₂₃ hydrocarbons & oxygenated organic compounds); and a small wax fraction 307 (C₂₂+ hydrocarbons & oxygenated organic compounds). A small quantity of gases (C₂-C₅) 302 are produced as well as a little residue (primarily oxidized hydrocarbons) 308.

Alternative or additional processes may be used to further distill the liquid hydrocarbons to separate the high value alpha-olefins and hydroxy-alkanes from the liquid fuels. An alternative embodiment includes the direct introduction of the liquid fuels into a co-located crude oil pipeline 117 at an oil well head, wherein it is mixed with the crude oil for conveyance to an oil refinery and/or chemical processing plant. Since the liquid fuels have a much lower density and viscosity than crude oil, they serve to improve the flow of the oil through pipelines.

Catalysts for the production of methanol may be used in the catalytic reactor in tandem with the catalytic reactor 108 to produce an intermediate methanol feedstock that can be transported to a refinery and/or chemical plant for further processing into fuels and/or chemicals. The plant may also be integrated with an ammonia production facility whereby the excess hydrogen from the GTL plant is used as a feedstock to the ammonia plant, thus optimizing the economics for production of this product.

In some cases, in order to prevent coking and other undesirable reactions in some syngas generators 103, the water to feedstock carbon ratio is adjusted in the range of 1.5-3.0/1.0, and preferably 2.0-3.0/1.0 to prevent coking and other undesirable reforming reactions. Although some make-up water may be needed when the integrated process described in FIG. 1 is started-up, there will be usually enough catalyst reaction water after start up to maintain an efficient catalyst steam reforming process without the need for make-up water.

In certain cases, processes according to the present invention are as follows:

A suitable hydrocarbon and/or vaporized liquid hydrocarbon resource is input into a syngas generator including a catalyst. In certain cases, the input is a natural gas stream or an individual component thereof. Adverse contaminants are removed from the gas-phase hydrocarbons before introduction into the syngas generator. One type of syngas generator uses steam to facilitate conversion of hydrocarbons to syngas. Another type of syngas generator utilizes a modified reciprocating engine to produce syngas.

Where steam facilitates hydrocarbon conversion, it primarily comes from direct recycling of water produced by the direct production process of the present invention. Typically, greater than 50 weight percent of the steam comes from direct recycling. Oftentimes, at least 60 weight percent, at least 70 weight percent, at least 80 weight percent or at least 90 weight percent of the steam comes from direct recycling.

The syngas generator catalyst converts hydrocarbons to syngas at temperatures below about 1700° F. An optional polishing unit is used to remove any syngas contaminants that may be present. If the ratio of H₂/CO in the syngas is too high, a membrane separation system may be employed to adjust the ratio. In certain cases, compression is used to increase the syngas pressure—e.g., pressure ranging from about 300 psi to about 500 psi, about 300 psi to about 450 psi, about 300 psi to about 400 psi, about 325 psi to about 475 psi. The syngas oxygen concentration is typically less than 1,000 ppm. Oftentimes the oxygen concentration is less than 750 ppm, 500 ppm or 250 ppm.

The generated syngas is input into multi-tubular catalytic reactors—usually 2, 3, 4 or 5 reactors—connected in series, configured in either a horizontal or vertical position or at an angle between horizontal and vertical. The catalytic reactors are typically run under the following temperature, pressure and gas space velocity conditions: about 400 to about 430° F.—e.g., about 400 to about 415° F. or about 415 to about 430° F.; about 250 to about 450 psig—e.g., about 250 to about 300 psig, about 300 psig to about 350 psig, about 350 psig to about 400 psig, about 400 psig to about 450 psig; an hourly space velocity of about 500 to about 3,000—e.g., about 500 to about 750, about 750 to about 1,000, about 1,250 to about 1,500, about 1,500 to about 1,750, about 1,750 to about 2,000, about 2,000 to about 2,250, about 2,250 to about 2,500, about 2,500 to about 2,750, about 2,750 to about 3,000.

Each catalytic reactor includes a catalyst, typically a supported catalyst. The catalyst support has a number of physical and chemical properties such as type of material, shape, pellet radius, mean pore diameter, crush strength, pore volume and surface area. Such properties typically range in value or identity as follows: materials including metal oxides (e.g., alumina, silica, zirconia, magnesium or combinations thereof), zeolites and carbon nanotubes having an approximately neutral surface pH (e.g., pH ranging from 6.5 to 7.5, pH ranging from 6.75 to 7.25, and preferably a pH of approximately 7.0); shapes including lobed (e.g., three, four or five lobes of equal or unequal lengths), fluted, vaned cross section, spherical, granule and powder; pellet radius of less than about 600 microns, less than 500 microns, less than 400 microns or less than 300 microns; mean pore diameter of greater than about 75 angstroms, greater than about 100 angstroms, greater than 110 angstroms, or greater than 120 angstroms; crush strength of about 1 lbs/mm to about 10 lbs/mm—e.g., about 1 lbs/mm to about 7.5 lbs/mm, about 1.5 lbs/mm to about 6.0 lbs/mm, about 2.0 lbs/mm to about 5.5 lbs/mm, about 2.5 lbs/mm to about 5.0 lbs/mm or about 3.0 lbs/mm to about 4.5 lbs/mm; BET surface area greater than about 75 m²/g, greater than about 100 m²/g, greater than 125 m²/g or greater than 150 m²/g.

The supported catalyst has a number of physical and chemical properties such as type of active metal, dispersion of active metal, weight percent of catalyst on the support, type of promoter and weight percent of promoter. Such properties typically range in value or identity as follows: active metal including cobalt, iron, nickel or combinations thereof; dispersion between about 2 percent and about 10 percent—e.g., about 2 percent to about 4 percent, about 4 percent to about 6 percent, about 6 percent to about 8 percent, about 8 percent to about 10 percent; weight percentage of catalyst on support between about 5 weight percent to about 30 weight percent, 10 weight percent to about 25 weight percent, 15 weight percent to about 25 weight percent, or 17.5 weight percent to about 22.5 weight percent; promoter including ruthenium, palladium, platinum, gold, nickel, rhenium, iridium, silver, osmium or combinations thereof; weight percentage of promoter between about 0.01 weight percent to about 2.0 weight percent—e.g., about 0.05 weight percent to about 1.75 weight percent, about 0.075 weight percent to about 1.50 weight percent, about 0.1 weight percent to about 1.25 weight percent, about 0.1 weight percent to about 1.0 weight percent, about 0.1 weight percent to about 0.75 weight percent, or about 0.1 weight percent to about 0.5 weight percent.

Where there are three multi-tubular catalytic reactors connected in series, the purified syngas is input into the first catalytic reactor. It is operated at temperatures, pressures and space velocities such that more than 25% of the CO and H₂ are converted into products. In certain cases, more than 30% are converted; in others about 35% are converted. The CO and H₂ and products remaining from reactor 1 are input into reactor 2, which is operated under conditions such that more than 35% of the input material is converted into products. In certain cases, more than 40%, more than 45%, or about 50% is converted. The remaining CO and H₂ and products are input into reactor 3, which is operated under conditions such that more than 50% of the input material is converted. In certain cases, more than 55%, more than 60%, or about 65% is converted. The serially-connected, multi-tubular catalytic reactors provide at least an 80% conversion efficiency of the CO and H₂ to liquid fuels (e.g., N-alkanes C5-C24). In certain cases, the reactors provide at least an 85% conversion efficiency, at least a 90% conversion efficiency, at least a 92.5% conversion efficiency or at least a 95% conversion efficiency. This is accomplished without re-compression and/or recycling of catalyst tail-gas.

The output (product) of the serially-connected, multi-tubular catalytic reactors typically includes liquid fuel and water. The liquid fuel and water usually each contain less than 500 ppm combined of acetic acid, propionic acid and malonic acid (“combined acids”). In certain cases, each contains less than 250 ppm of the combined acids, less than 200 ppm of the combined acids, less than 150 ppm of the combined acids, less than 100 ppm of the combined acids, less than 50 ppm of the combined acids or less than 25 ppm of the combined acids.

In other cases, processes according to the present invention are as follows:

1) The syngas generator uses steam to facilitate conversion of hydrocarbons to gas. Greater than 60 weight percent or 70 weight percent or 80 weight percent of steam comes from direct recycling of water produced by the production process of the present invention. Syngas oxygen concentration is less than 1,000 ppm or less than 500 ppm. Three multi-tubular catalytic reactors are connected horizontally in series. Operating conditions: 400 to about 430° F.; about 250 psig to about 350 psig or about 350 psig to about 450 psig; space velocity of about 500 to about 1,750 or about 1,750 to about 3,000. Supported catalyst, where the support has an approximately neutral pH, and where the support has the following physical and chemical properties: alumina as material; lobed as shape; pellet radius less than about 500 microns; mean pore diameter greater than 110 angstroms; crush strength of about 3 lbs/mm to about 4.5 lbs/mm; BET surface area greater than 100 m²/g or greater than 125 m²/g. The catalyst has the following physical and chemical properties: active metal is cobalt; active metal distribution between about 2 percent to about 4 percent or about 4 percent to about 6 percent; weight percent of active metal on support of between about 15 weight percent and 25 weight percent; promoter is ruthenium, rhenium, palladium or platinum; weight percentage of promoter between about 0.1 weight percent to about 0.5 weight percent. First reactor connected in series converts more than 30% of CO and H₂ into products; second reactor converts more than 45% of input material into products; third reactor converts more than 60% of input material into products. The three reactors in series provide at least a 90%, at least a 92.5% conversion efficiency or at least a 95% conversion efficiency. This is accomplished without re-compression and/or recycling of catalyst tail-gas. Produced liquid fuel and water each include less than 100 ppm of acetic acid, propionic acid and malonic acid combined, less than 50 ppm combined, and preferably less than 25 ppm combined. The product water is directly recycled to provide steam for the syngas generator.

2) The syngas generator uses steam to facilitate conversion of hydrocarbons to syngas. Greater than 60 weight percent or 70 weight percent or 80 weight percent of steam comes from direct recycling of water produced by the production process of the present invention. The syngas oxygen concentration is less than 1,000 ppm, less than 500 ppm, or preferably less than 250 ppm. Three multi-tubular catalytic reactors connected horizontally in series: Operating conditions: 400 to about 430° F.; about 250 psig to about 350 psig or about 350 psig to about 450 psig; gas hourly space velocity of about 500 to about 1,750 or about 1,750 to about 3,000. Supported catalyst, where the support has an approximately neutral pH, and where the support has the following physical and chemical properties: alumina as material; lobed as shape; pellet radius less than about 500 microns; mean pore diameter greater than 110 angstroms; crush strength of about 3 lbs/mm to about 4.5 lbs/mm; BET surface area greater than 100 m²/g or greater than 125 m²/g. The catalyst has the following physical and chemical properties: active metal is iron; active metal distribution between about 2 percent to about 4 percent or about 4 percent to about 6 percent; weight percent of active metal on support of between about 15 weight percent and 25 weight percent; promoter is ruthenium, rhenium, palladium or platinum; weight percentage of promoter between about 0.1 weight percent to about 0.5 weight percent. First reactor connected in series converts more than 30% of CO and H₂ into products; second reactor converts more than 45% of input material into products; third reactor converts more than 60% of input material into products. The three reactors in series provide at least a 90%, at least a 92.5% conversion efficiency or at least a 95% conversion efficiency. This is accomplished without re-compression and/or recycling of catalyst tail-gas. Produced liquid fuel and water each include less than 100 ppm of acetic acid, propionic acid and malonic acid combined. Product water is directly recycled to provide steam for the syngas generator.

3) The syngas generator uses steam to facilitate conversion of hydrocarbons to gas. Greater than 60 weight percent or 70 weight percent or 80 weight percent of steam comes from direct recycling of water produced by the production process of the present invention. Syngas oxygen concentration is less than 1,000 ppm or less than 500 ppm. Three multi-tubular catalytic reactors connected horizontally in series. Operating conditions: 400 to about 430° F.; about 250 psig to about 350 psig or about 350 psig to about 450 psig; space velocity of about 500 to about 1,750 or about 1,750 to about 3,000. Supported catalyst, where the support has an approximately neutral pH, and where the support has the following physical and chemical properties: alumina as material; lobed as shape; pellet radius less than about 500 microns; mean pore diameter greater than 110 angstroms; crush strength of about 3 lbs/mm to about 4.5 lbs/mm; BET surface area greater than 100 m²/g or greater than 125 m²/g. The catalyst has the following physical and chemical properties: active metal is nickel; active metal distribution between about 2 percent to about 4 percent or about 4 percent to about 6 percent; weight percent of active metal on support of between about 15 weight percent and 25 weight percent; promoter is ruthenium, rhenium, palladium or platinum; weight percentage of promoter between about 0.1 weight percent to about 0.5 weight percent. First reactor connected in series converts more than 30% of CO and H₂ into products; second reactor converts more than 45% of input material into products; third reactor converts more than 60% of input material into products. The three reactors in series provide at least a 90%, at least a 92.5% conversion efficiency or at least a 95% conversion efficiency. This is accomplished without re-compression and/or recycling of catalyst tail-gas. Produced liquid fuel and water each include less than 100 ppm of acetic acid, propionic acid and malonic acid combined, less than 50 ppm combined, and preferably less than 25 ppm combined. Product water is directly recycled to provide steam for the syngas generator.

4) The syngas generator utilizing a modified reciprocating engine. Greater than about 70 weight percent, preferably about 80 weight percent, or more preferably 90 weight percent of steam comes from direct recycling of water produced by the production process of the present invention. Syngas oxygen concentration is less than 1,000 ppm, less than 500 ppm, or preferably less than 250 ppm. Three multi-tubular catalytic reactors connected horizontally in series. Operating conditions: 400 to about 430° F.; about 250 psig to about 350 psig or about 350 psig to about 450 psig; space velocity (GHSV) of about 500 to about 1,750 or about 1,750 to about 3,000. Supported catalyst, where the support has an approximately neutral pH, and where the support has the following physical and chemical properties: alumina as material; lobed as shape; pellet radius less than about 500 microns; mean pore diameter greater than 110 angstroms; crush strength of about 3 lbs/mm to about 4.5 lbs/mm; BET surface area greater than 100 m²/g or greater than 125 m²/g. The catalyst has the following physical and chemical properties: active metal is cobalt; active metal distribution between about 2 percent to about 4 percent or about 4 percent to about 6 percent; weight percent of active metal on support of between about 15 weight percent and 25 weight percent; promoter is ruthenium, rhenium, palladium or platinum; weight percentage of promoter between about 0.1 weight percent to about 0.5 weight percent. First reactor connected in series converts more than 30% of CO and H₂ into products; second reactor converts more than 45% of input material into products; third reactor converts more than 60% of input material into products. The three reactors in series provide at least a 90%, at least a 92.5% conversion efficiency or at least a 95% conversion efficiency. This is accomplished without re-compression and/or recycling of catalyst tail-gas. Produced liquid fuel and water each include less than about 100 ppm of acetic acid, propionic acid and malonic acid combined, less than 50 ppm combined, and preferably less than 25 ppm combined. The product water is used in a tertiary oil recovery process.

5) The syngas generator utilizing a modified reciprocating engine. Greater than 60 weight percent or 70 weight percent, 80 weight percent of steam, or preferably 90 weight percent of steam comes from direct recycling of water produced by the production process of the present invention. Syngas oxygen concentration is less than 1,000 ppm, less than 500 ppm, or preferably less than 250 ppm. Three multi-tubular catalytic reactors connected horizontally in series. Operating conditions: 400 to about 430° F.; about 250 psig to about 350 psig or about 350 psig to about 450 psig; space velocity (GHSV) of about 500 to about 1,750, or about 1,750 to about 3,000. Supported catalyst, where the support has an approximately neutral pH, and where the support has the following physical and chemical properties: alumina as material; lobed as shape; pellet radius less than about 500 microns; mean pore diameter greater than 110 angstroms; crush strength of about 3 lbs/mm to about 4.5 lbs/mm; BET surface area greater than 100 m²/g or greater than 125 m²/g. The catalyst has the following physical and chemical properties: active metal is iron; active metal distribution between about 2 percent to about 4 percent or about 4 percent to about 6 percent; weight percent of active metal on support of between about 15 weight percent and 25 weight percent; promoter is ruthenium, rhenium, palladium or platinum; weight percentage of promoter between about 0.1 weight percent to about 0.5 weight percent. First reactor connected in series converts more than 30% of CO and H₂ into products; second reactor converts more than 45% of input material into products; third reactor converts more than 60% of input material into products. The three reactors in series provide at least a 90%, at least a 92.5% conversion efficiency or at least a 95% conversion efficiency. This is accomplished without re-compression and/or recycling of catalyst tail-gas. Produced liquid fuel and water each include less than 100 ppm of acetic acid, propionic acid and malonic acid combined, less than 50 ppm combined, and preferably less than 25 ppm combined. Product water is used in a tertiary oil recovery process.

6) The syngas generator utilizing a modified reciprocating engine. Greater than 60 weight percent or 70 weight percent or 80 weight percent of steam comes from direct recycling of water produced by the production process of the present invention. Syngas oxygen concentration is less than 1,000 ppm, less than 500 ppm, or preferably less than 250 ppm. Three multi-tubular catalytic reactors connected horizontally in series. Operating conditions: 400 to about 430° F.; about 250 psig to about 350 psig or about 350 psig to about 450 psig; space velocity (GHSV) of about 500 to about 1,750 or about 1,750 to about 3,000. Supported catalyst, where the support has an approximately neutral pH, and where the support has the following physical and chemical properties: alumina as material; lobed as shape; pellet radius less than about 500 microns; mean pore diameter greater than 110 angstroms; crush strength of about 3 lbs/mm to about 4.5 lbs/mm; BET surface area greater than 100 m²/g or greater than 125 m²/g. The catalyst has the following physical and chemical properties: active metal is nickel; active metal distribution between about 2 percent to about 4 percent or about 4 percent to about 6 percent; weight percent of active metal on support of between about 15 weight percent and 25 weight percent; promoter is ruthenium, rhenium, palladium or platinum; weight percentage of promoter between about 0.1 weight percent to about 0.5 weight percent. First reactor connected in series converts more than 30% of CO and H₂ into products; second reactor converts more than 45% of input material into products; third reactor converts more than 60% of input material into products. The three reactors in series provide at least a 90%, at least a 92.5% conversion efficiency or at least a 95% conversion efficiency. This is accomplished without re-compression and/or recycling of catalyst tail-gas. Produced liquid fuel and water each include less than 100 ppm of acetic acid, propionic acid and malonic acid combined. Product water is used in a tertiary oil recovery process.

Where process “1”, “2” or “3” above is used in a Micro-GTL plant that converts about 0.05-2.5 million scf/day of gas-phase hydrocarbons into about 5-250 barrels/day of liquid fuels, and where the Micro-GTL plant is located at a site such that water must be shipped the site (i.e., brought to the site using ground, air or water shipment from a location at least 2.5 miles away) to provide steam to facilitate conversion of hydrocarbons to gas, recycling of the water containing less than about 100 ppm of acetic acid, propionic acid and malonic acid combined decreases the cost of liquid fuel production by at least 1 percent. In certain cases, it decreases the cost of liquid fuel production by at least 2 percent, at least 3 percent, at least 4 percent, or at least 5 percent.

Where process “1”, “2” or “3” above is used in a Micro-GTL plant that converts about 0.05-2.5 million scf/day of gas-phase hydrocarbons into about 5-250 barrels/day of liquid fuels, and where the Micro-GTL plant is located at a site such that desalinated water must be used (e.g., water from a salt water source where that water has been treated to remove all or a substantial amount of the salt) to provide steam to facilitate conversion of hydrocarbons to gas, recycling of the water containing less than about 100 ppm of acetic acid, propionic acid and malonic acid combined decreases the cost of liquid fuel production by at least 1 percent. In certain cases, it decreases the cost of liquid fuel production by at least 2 percent, at least 3 percent, at least 4 percent, or at least 5 percent.

Where process “4”, “5” or “6” above is used in a Micro-GTL plant that converts about 0.05-2.5 million scf/day of gas-phase hydrocarbons into about 5-250 barrels/day of liquid fuels, the amount of oil recovered through the tertiary oil recovery process using the product water averages at least one barrel per day over a period of at least 30 days. In certain cases, it averages at least two barrels per day, at least five barrels per day or at least 10 barrels per day over a period of at least 30 days.

Liquid fuels produced according to the present invention can be stored in a steel, plastic or other types of tanks typically used to store fuels, at an average temperature greater than or equal to 60° F. for at least six months without generating more than 25 g sediments/m³ of fuel according to the EN 1575 I standard without the addition of a biocide or fuel stability treatment. See Czarnock et al. “Diesel Fuel Degradation During Storage Proces”, CHEMIK 2015, 69, 11, 771-778. In certain cases, the liquid fuel can be stored under the same conditions without generating more than 20 g sediments/m³, without generating more than 15 g sediments/m³, without generating more than 10 g sediments/m³, or without generating more than 5 g sediments/m³ without addition of a biocide or fuel stability treatment.

The foregoing descriptions of embodiments for this invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the attached claims.

### Examples

Examples are provided for processes and how those processes can best be integrated with embodiments of the unit processes for the micro-scale GTL process of the present invention.

Although there are many processes available for the production of syngas from gas-phase hydrocarbon resource, catalytic steam reforming is a typical syngas generation process since methane can be converted to syngas at temperatures below about 1,700° F. and typically in the 1,600-1,650° F. range, for which the conversion of methane is more than 97% efficient.

The average composition of gas-phase hydrocarbon resources from oil wells varies widely, depending upon the location as presented in Table 5. However, for the purpose of simplicity the average composition of the gas-phase hydrocarbons from North Dakota will be used to demonstrate the two preferred reforming processes.

TABLE 5
The Average Composition of Gases Produced from
Oil Wells in North Dakota and New Mexico

Concentration (Volume %)

| | North Dakota | New Mexico |
|---|---|---|
| Gas-Phase Constituents | (Average) | (Range) |
| Methane | 59.3 | 74-95 |
| Ethane | 17.7 | 0-10 |
| Propane | 9.4 | 0-5 |
| Butane | 2.7 | 0-3 |
| Pentane+ | 0.92 | 0-0.5 |
| Carbon Dioxide | 0.51 | 0-10 |
| Oxygen | Not determined | 0-0.2 |
| Nitrogen | 7.1 | 0-3 |

Although the catalytic steam reforming of the methane should ideally produce a H₂/CO ratio of 3.0/1.0 according to the reaction in Eq. 1, additional H₂ is produced from some of the methane in the syngas according to Eq. 2, resulting in the reaction stoichiometry given by Eq. 3.

CH₄+H₂O→CO+3H₂ Eq. 1 (major)

0.20CH₄+0.3H₂O→0.1CO₂+0.1CO+0.7H₂ Eq. 2(minor)

1.2CH₄+1.3H₂O→1.1CO+0.1CO₂+3.7H₂ Eq. 3(combined)

As a result, the ratio of H₂/CO generated from a catalytic methane steam reformer is typically greater than 3.0 (Norbeck et al, 2008). As shown by equation 3, the ratio of H₂/CO is 3.36. The required molar ratio of H₂O to carbon should be at least 1.08 according to equation 3, but preferably in the range of 1.5-3.0 to eliminate the possibility of elemental carbon formation.

The catalytic steam reforming of ethane, the second most abundant gas-phase hydrocarbon in the North Dakota sample, produces syngas with an H₂/CO ratio of 2.50/1.0 as given by Equation 4.

C₂H₆+2H₂O→2CO+5H₂ Eq. 4

The catalytic steam reforming of propane, the third most abundant gas-phase hydrocarbon in the North Dakota sample produces syngas with an H₂/CO ratio of 2.33/1.0 as given by Equation 5.

C₃H₈+3H₂O→3CO+7H₂ Eq. 5

Table 6 summarizes the composition of the syngas that is generated from the syngas generator when inputting the average of the gas-phase hydrocarbons produced from oil wells in North Dakota. The H₂/CO ratio is 3.00 in this case.

TABLE 6
The Average Composition of Syngas produced from the
Conversion of North Dakota Flared Gas using Catalytic
Steam Reforming at ~1625° F.

| | Syngas Components | | | | | | |
|---|---|---|---|---|---|---|---|
| | H₂ | CO | CH₄ | C₂+ | CO₂ | N₂ | Total |
| Volume % | 70.4 | 23.5 | 2.0 | 0.3 | 2.4 | 1.7 | 100.0 |

Table 7 summarizes the average composition of syngas produced from the conversion of North Dakota flared gas using catalytic steam reforming at ˜1625° F. after membrane separation of the H₂ to adjust the H₂/CO ratio to about 2.20/1.00.

TABLE 7
The Average Composition of Syngas produced from the
Conversion of North Dakota Flare Gas using Catalytic
Steam Reforming at ~1625° F. and Membrane separation of
H₂ to adjust the H₂/CO Ratio to 2.20/1.00

| | Syngas Components | | | | | | |
|---|---|---|---|---|---|---|---|
| | H₂ | CO | CH₄ | C₂+ | CO₂ | N₂ | Total |
| Volume % | 63.4 | 28.8 | 2.5 | 0.3 | 2.9 | 2.1 | 100.0 |

A second preferred syngas generator 103 employs a reciprocating diesel engine that has been reconfigured to operate on gas-phase hydrocarbons in a dual fuel mode. When this engine is operated under rich conditions (e.g., at an equivalence [fuel/air] ratio greater than about 1.8), syngas is produced from the gas-phase hydrocarbons.

Table 8 summarizes the effect of equivalence ratios on CH₄ conversion, H₂/CO ratios and particulate emissions. A VPSA system is used to increase the concentration of oxygen in air from 21% to about 93%. This level of enrichment allows the engine to operate at equivalence ratio of 2.0-2.2 and significantly reduces the concentration of nitrogen in the syngas. At this equivalence ratio, methane is converted with an efficiency of about 91-93% to syngas that has an H₂/CO ratio of 1.62-1.85.

If a small amount of H₂ (about 5%) 107 is added to the gas-phase hydrocarbons, the H₂/CO ratio is increased to 1.83 and 1.95 at equivalence ratios of 2.0 and 2.2, respectively. This quantity of H₂ can be provided by recycling the tailgas 111 to the syngas generator 103.

The particulate emissions at the equivalence ratios of 2.0-2.2 are about 0.09-0.13 mg/L (90,000-130,000 micrograms/cubic meter). Since the contaminant specification for the catalysts in the catalytic reactor is 500 micrograms/cubic meter or less, these levels of particulate emissions need to be significantly reduced.

Since diesel engine particulate traps are well established technologies, the addition of particulate traps to this engine reformer, can reduce the particulate emissions to below 500 micrograms/cubic meter. These particulate traps can be operated in a lag/lead mode so that the flow of syngas is not interrupted.

TABLE 8
The Effect of Equivalence Ratio on CH₄ Conversion,
H₂/CO Ratios and Particulate Emissions for the
Reciprocating Engine Reformer

| Equi- | | | | Particulate Emissions | |
|---|---|---|---|---|---|
| valence | | H₂/CO Ratios | | (mg/m³) | |
| Ratio | % CH₄ | No H₂ | 5% H₂ | No H₂ | 5% H2 |
| (CH₄/O₂) | Conversion | Addition | Addition | Addition | Addition |
| 2.0 | 91 | 1.62 | 1.83 | 0.14 | 0.09 |
| 2.2 | 93 | 1.85 | 1.95 | 0.18 | 0.13 |

Table 9 gives the average composition of syngas produced from the conversion of North Dakota flared gas using the reciprocating engine reformer when tailgas from the catalytic reactor is recycled back to the engine reformer. The H₂/CO ratio of the syngas is about 1.95 at an equivalence ratio of 2.2. This ratio is in the acceptable range for the direct fuel production catalyst.

TABLE 9
The Average Composition of Syngas produced from Conversion
of North Dakota Flared Gas to Syngas using the Reciprocating
Engine Reformer (Equivalence Ratio: 2.2) with Recycling
of Tailgas from the Catalytic Reactor

| H₂ | CO | CH₄ | CO₂ | N₂ | Total |
|---|---|---|---|---|---|
| 45 | 23 | 19 | 4 | 9 | 100.0 |

Catalytic reactor 108 consists of a series of several reactors connected in series for the efficient single-pass, direct conversion of the syngas into premium fuels. This configuration eliminates the need for re-compression and recycling of the tailgas through the catalytic reactor, which is typically employed in the existing art. This example illustrates how the three reactors are able to convert about 90 mole % of H₂ and CO in the syngas to products without re-compression and recycling of the syngas. The composition of syngas (Table 10) produced from the syngas generator 103 using catalytic steam reforming is used as the input to the catalytic reactor 108 using the direct fuel production catalyst 109.

TABLE 10
The Conversion of Syngas and Formation of Products in the
Catalytic Reactor using the Direct Fuel Production Catalyst

| | Composition (volume %) | | | | |
|---|---|---|---|---|---|
| | Input from | Output | Output | Output | Output |
| | Syngas | from 1^{st} | from 2^{nd} | from 3^{rd} | from 4^{th} |
| Components | Generator¹ | Reactor | Reactor | Reactor | Reactor |
| H₂ | 63.4 | 55.8 | 36.3 | 22.1 | 5.7 |
| CO | 28.8 | 25.8 | 17.6 | 10.9 | 3.5 |
| CH₄ | 2.5 | 2.9 | 3.5 | 6.2 | 13.1 |
| H₂/CO | 2.20 | 2.12 | 2.06 | 2.03 | 1.97 |
| C₂-C₄ HC's | 0.3 | 1.1 | 1.8 | 2.9 | 3.9 |
| CO₂ | 2.9 | 3.2 | 4.7 | 6.6 | 7.1 |
| N₂ | 2.1 | 2.3 | 3.4 | 4.5 | 5.9 |
| Sub-Total | 100.0 | 91.1 | 67.3 | 53.2 | 39.2 |
| Non-Condensable | | | | | |
| Products | | | | | |
| C₅-C₂₄ HC's | — | 8.9 | 32.5 | 46.4 | 59.8 |
| C₂₄ + HC's | — | — | 0.2 | 0.4 | 0.6 |
| Sub-Total | 0.0 | 8.9 | 32.7 | 46.8 | 60.8 |
| Condensable | | | | | |
| Products | | | | | |
| Total | 100.0 | 100.0 | 100.0 | 100.0 | 100.0 |

In this example, 10.4%, 38.9%, 62.2% and 88.9% of the CO is cumulatively converted to products in the first, second, third and fourth reactors, respectively. The total conversion of H₂ and CO is 90.0% and 88.9%, respectively. The condensable products (C₅-C₂₄) and non-condensable tailgas represent 60.8 volume % and 39.2 volume % of the total gas-phase components. Table 11 provides the composition of the tailgas after the condensable products are removed.

TABLE 11
Tailgas Composition after Conversion of Syngas in the Catalytic
Reactors with the Direct Fuel Production Catalyst

| H₂ | CO | CH₄ | C₂-C₅ | CO₂ | N₂ | Total |
|---|---|---|---|---|---|---|
| 14.5 | 8.9 | 33.4 | 9.9 | 18.1 | 15.1 | 100.0 |

In conclusion, this series of four, horizontal or vertical catalytic reactors, or reactors at an angle between horizontal and vertical, efficiently converts about 90% of the H₂ and CO in the syngas to products while keeping the temperatures and pressures of the gases in each reactor constant. In addition, the removal of products from each stage and recycling of tailgas to the reactors is not necessary.

The direct fuel production catalyst is operated at temperature, pressure and space velocity conditions so that about 90% of the H₂ and CO in the syngas is converted to products. The liquid fuels, which consist of C₅-C₂₄ hydrocarbons, represent above about 60 volume %, about 70 volume %, or preferably 75 volume % of the gas-phase constituents exiting the catalytic reactor. These gas-phase constituents are collected as liquid fuels in the product separation and collection unit (FIG. 1: 110). FIG. 4 illustrates the typical distribution of C₅-C₂₄ hydrocarbons when the H₂/CO ratio in the syngas from the catalytic steam reformer is input at about 2.20/1.0 with an average input and output ratio of 2.08/1.0.

The distribution illustrated in FIG. 4 is shifted slightly to the left (lighter distribution) as the H₂/CO ratio increases above 2.08 and slightly to the right (heavier distribution) as the H₂/CO ratio decreases below 2.08.

The composition of the fuel at the average H₂/CO ratio of 2.08 is provided in Table 12. Normal alkanes (N-alkanes) in the C₈ to C₂₄ range are the most abundant hydrocarbons at 65.4 volume %. Normal C₅ to C₇ alkane's represent 17.5 volume % of the total. About 1.0 volume % of the sample is wax (C₂₄+) hydrocarbons. Normal 1-alkenes, normal 1-hydroxy-alkanes and iso-alkanes comprise the remainder of the liquid fuel sample.

In the same system and using the same catalyst, by shifting the H₂:CO ratio to an input ratio of 1.7 then the output product shifts to minimize C₄-C₇ fraction and maximize diesel (including a heavy diesel or light wax fraction).

In the same system and using the same catalyst the pressure in the reactor can be changed to pressures greater than 350 psig to shift the product heavier (e.g. higher MW distribution). In the same system and using the same catalyst the temperature in the reactor can be changed to less than 410° F. to shift the product heavier. In the same system and using the same catalyst the gas hourly space velocity (GHSV) in the reactor can be changed to less than 2000 hr⁻¹ to shift the product heavier.

FIG. 5 shows the effect of varying the H₂/CO ratio on the concentration of 1-alkenes in liquid fuel. The concentration of these alkenes varies from about 3.5 volume % at an H₂/CO ratio of 2.2 to 15.0% at an H₂/CO ratio of 1.5.

TABLE 12
Composition of the Liquid Fuel

| Liquid Fuel Composition | Volume % |
|---|---|
| N-Alkanes (C₅-C₇) | 17.5 |
| N-Alkanes (C₈-C₂₄) | 65.4 |
| N-Alkanes (C₂₄+) | 1.0 |
| Normal 1-Alkenes (alpha-olefins) (C₅-C₇) | 1.39 |
| Normal 1-Alkenes (alpha-olefins) (C₈-C₂₄) | 1.78 |
| Normal 1-Hydroxy-Alkanes (C₅-C₇) | 0.76 |
| Normal 1-Hydroxy-Alkanes (C₈-C₂₄) | 3.91 |
| Iso-Alkanes (C₅-C₇) | 2.60 |
| Iso-Alkanes (C₈-C₂₄) | 5.70 |
| Total | 100.0 |

When the product collection and separation unit is operated at 50-55° F., the tail-gas composition is similar to that presented in Table 11. The tailgas contains CH₄ (33.4%) which is primarily produced from the catalytic reaction of the syngas. Small quantities of C₂-C₅ hydrocarbons are generated from the catalytic reaction and since they have a high vapor pressure they are not condensed as liquid fuels. Some unreacted H₂ and CO is also present since the direct fuel production reactor is operated under conditions that convert about 89% of the CO to products.

The amount of nitrogen in the tail-gas is dependent upon the concentration of nitrogen in the gas-phase hydrocarbon feedstock. If the engine reformer is used to produce syngas, the concentration of nitrogen in the tail-gas may be increased substantially. Table 13 summarizes the composition of the syngas that is produced when the tailgas 111 and catalyst reaction water 112 are recycled to the syngas generator 103 using catalytic steam reforming using the average North Dakota flare gas composition.

TABLE 13
The Composition of the Syngas from the Syngas Generator
using Catalytic Steam Reforming and Recycling of
the Catalyst Reaction Water and Tailgas

| H₂ | CO | CH₄ | C₂-C₅ | CO₂ | N₂ | Total |
|---|---|---|---|---|---|---|
| 56.3 | 28.1 | 2.0 | 1.0 | 8.0 | 4.6 | 100.0 |

Table 14 summarizes the average, total yield (gallons) of fuel produced from 30,000 scf of methane converted to syngas with an average H₂/CO ratio of 2.08 using this process. This volume of methane was chosen since it contains about 1,000 lbs. of carbon. Therefore, the average production of fuel produced from 500,000 scf/day of methane is approximately 2,315 gallons/500,000 scf or about 55 barrels/500,000 scf.

TABLE 14
The Total Yield (Gallons/30,000 scf) of
Fuel Products produced from Methane

| Test # | Gallons/30,000 scf CH₄ |
|---|---|
| 8b | 138 |
| 16a | 140 |
| 17g | 133 |
| Average | 139 |

Table 12 summarized the concentrations of oxygenated organic compounds in the catalyst reaction water produced using syngas produced from different feedstocks using this micro-scale GTL process. The oxygenated organic compounds in the catalyst reaction water are comprised of C₁ to C₇ hydroxy-alkanes (alcohols) for syngas generated from three gas-phase hydrocarbon feedstocks. No carboxylic acids were detected (<25 ppm) below the GC/MS detection limit in these water samples.

When the catalyst reaction water containing these hydroxy-alkanes are recycled to the syngas generator, the catalytic steam-reforming of the alcohols reduce the H₂/CO ratio. Equations 3, 4 and 5 illustrate the reaction products and resulting product stoichiometry from the reforming of methanol, ethanol and propanol as examples.

CH₃OH+H₂O→CO+2H₂+H₂O Eq. 3

CH₃CH₂OH+2H₂O→2CO+4H₂+H₂O Eq. 4

CH₃CH₂CH₂OH+3H₂O→3CO+6H₂+H₂O Eq. 5

When steam is not used in the syngas production process, the catalyst reaction water is ideal for water injection into oil wells for enhanced oil recovery.

### REFERENCES

References related to topics discussed in this document are summarized as U.S. patents; U.S. patent Publications; Foreign patents and articles in journals and books.

### U.S. Patents

| Cited Patents | Date | Authors |
|---|---|---|
| 9,138,688 B2 | September 2015 | Prakash et al. |
| 9,090,831 B2 | July 2015 | Schuelzle el al. |
| 9,067,806 B2 | June 2015 | Carnelli et al. |
| 8,999,164 B2 | April 2015 | Franzosi et al. |
| 8,795,597 B2 | August 2014 | Greer |
| 8,727,767 B2 | May 2014 | Watson et al. |
| 8,591,737 B2 | November 2013 | Kukkonen et al. |
| 8,535,487 B2 | September 2013 | Carnelli et al. |
| 8,529,865 B2 | September 2013 | Belt et al. |
| 8,394,862 B2 | August 2013 | Schuetzle et al. |
| 8,293,805 B2 | October 2012 | Khan et al. |
| 8,158,029 B2 | April 2012 | Ernst |
| 8,057,578 B2 | November 2011 | Argawal et al. |
| 8,048,178 B2 | November 2011 | Smit et al. |
| 8,043,571 B2 | October 2011 | Dannoux et al. |
| 7,989,510 B2 | August 2011 | Locatelli et al. |
| 7,939,953 B2 | May 2011 | Lomax et al. |

### U.S. Patents

| Cited Patents | Date | Authors |
|---|---|---|
| 7,744,829 B2 | June 2010 | Brophy et al. |
| 7,559,372 B2 | July 2009 | Cobb |
| 7,470,405 B2 | November 2008 | Knopf et al. |
| 7,404,936 B2 | July 2008 | Mazanec et al. |
| 7,323,497 B2 | January 2008 | Abbot |
| 7,318,894 B2 | January 2008 | Juby et al. |
| 7,276,105 B2 | October 2007 | Pruet et al. |
| 7,261,751 B2 | August 2007 | Dutta et al. |
| 7,235,172 B2 | June 2007 | Lawson et al. |
| 7,166,219 B2 | January 2007 | Kohler et al. |
| 7,153,432 B2 | December 2006 | Kohler et al. |
| 7,150,831 B2 | December 2006 | Kohler et al. |
| 7,147,775 B2 | December 2006 | Kohler et al. |
| 7,108,070 B2 | September 2006 | Hall et al. |
| 6,942,839 B2 | September 2005 | Huisman et al. |
| 6,887,908 B2 | May 2005 | Pruet et al. |
| 6,744,066 B2 | June 2004 | Wang et al. |
| 6,576,196 B1 | May 2003 | Akporiaye et al. |
| 6,533,945 B1 | March 2003 | Shah et al. |
| 6,262,131 B1 | July 2001 | Arcuri et al. |
| 6,225,358 A | May 2001 | Kennedy et al. |
| 6,156,809 A | December 2000 | Clark et al. |
| 5,620,670 A | April 1997 | Benham et al. |
| 5,053,581 A | October 1991 | Hildinger et al. |
| 4,499,209 A | February 1985 | Hoek et al. |

### U.S. Patent Publications

| Patent Publications | Date | Authors |
|---|---|---|
| 2015/0259609 A1 | September 2015 | Wang et al. |
| 2014/0144397 A1 | May 2014 | Bromberg et al. |
| 2014/102981 A1 | April 2014 | Miglio et al. |
| 2014/0140896 A1 | May 2014 | Moon et al. |
| 2012/0071572 A1 | March 2012 | Voolapelli et al. |
| 2010/0184874 A1 | July 2010 | Hoek et al. |
| 2010/0000153 A1 | January 2010 | Kurkjian et al. |
| 2007/095570 A1 | August 2007 | Tomlinson et al. |
| 2005/113426 A1 | November 2005 | Clur et al. |
| 2005/0106086 A1 | May 2005 | Tomlinson et al. |
| 2004/0262199 | December 2005 | Roelofse et al. |
| 2003/0225169 | December 2003 | Yetman |

### Other Patent Applications

| Other Patents | Date | Authors |
|---|---|---|
| WO2016/016256 A1 | February 2016 | Basini |
| WO2015/00646 A1 | January 2015 | Tessel |
| WO2012/158536 A1 | November 2012 | Boel et. al. |
| WO2010/06958 A1 | June 2010 | Carnelli et. al. |
| WO2009/0901005 A1 | July 2009 | Carnelli et. al. |
| WO2006/037782 A1 | April 2006 | Scholten et al. |
| WO2005/113426 B1 | December 2005 | Clur et. al. |
| WO2004/096952 A1 | November 2004 | Abbott et. al. |
| WO2003/106346 A1 | December 2003 | Dancuart |

### Articles in Journals and Books

Asadullah, M.: Biomass gasification gas cleaning for downstream applications: A comparative critical review. Renewable and Sustainable Energy Reviews 40, 118-131 (2014).
ASTM International, Standard test method for corrosiveness to Copper from petroleum products by Copper Strip Test, ASTM D130-12, Conshohocken, Pa. (2012).
De Klerk, A.: Fischer-Tropsch (F-T) refining. Wiley Verlag, Weinheim, Germany, 1-642 (2012).
Hoekman, S. K. et al.: Characterization of trace contaminants in syngas from the thermochemical conversion of biomass. Biomass Conversion and Biorefinery 3, 113-126 (2013).
Jahnagiri, H., Bennett, J., Mahjoubi, P., Wilson, K., Gu, S.: A review of advanced catalyst development for Fischer-Tropsch synthesis of hydrocarbons from biomass derived syngas. Catalysis Science and Technology 4, 2210-2229 (2014).
Lee, H-J.: Optimization of Fischer-Tropsch Plant, PhD Thesis, School of Chemical Engineering and Analytical Science, University of Manchester (2010).
Lin, H., Zhou, M., Ly, J., Vu, J., Wijmans, J. G., Merkel, T. C., Jin, J., Haldeman, A., Wagener, E. H., Rue, D.: Membrane-Based Oxygen-Enriched Combustion, Ind. Eng. Chem. Res., 52, 10820-10834 (2013).
Lim, E. G. et al.: The engine reformer: syngas production in an engine for compact gas-to-liquid synthesis. Canadian Journal of Chemical Engineering 34 (2016).
McKendry, P.: Energy production from biomass gasification technologies 83, 55-63 (2002).
O'Brien, R. J., Davis, B. H.: Impact of copper on an alkali promoted iron Fischer-Tropsch catalyst. Catalysis Letters 64 (2004).
Sa, S., Silva, H., Brandao, L., Mendes, A.: Catalysts for methanol steam reforming. Applied Catalysis B Environmental 99, 43-57 (2010).
Schuetzle, D. et al.: The effect of oxygen on formation of syngas contaminants during the thermochemical conversion of biomass. International Journal of Energy and Environmental Engineering, Springer-Verlag GmbH, Berlin, Heidelberg, Online ISSN: 2251-6832 and Print ISSN: 2008-9163, 1-13 (2015).
Wang, X. et al.: Dilution sampling and analysis of particulate matter in biomass-derived syngas. Frontiers of Environmental Science & Engineering 5, 320-330 (2011).
Yaying, J.: Partial oxidation of methane with air or O₂ and steam to synthesis gas over a Ni-based catalyst. Journal of Natural Gas Chemistry 9, 291-303 (2000).

1. A process for producing two or more fuel products from gas-phase hydrocarbon feedstocks comprising:
a) producing syngas from gas-phase hydrocarbon feedstocks using a syngas generator, wherein the syngas has a H₂/CO ratio of about 1.5-3.3;
b) converting syngas into fuels using a catalytic reactor comprising two or more horizontal reactors, vertical reactors, or reactors that are angled between a horizontal and vertical orientation, and that are connected in series, wherein the catalytic reactor comprises a catalyst for the direct conversion of the syngas into liquid fuels, and wherein liquid fuels and catalyst reaction water are produced, and wherein the catalyst produces undetectable levels of carboxylic acids in the fuels and catalyst reaction water;
c) separating the catalyst reaction water from the liquid fuels and recycling the water to the syngas generator;
d) distilling the liquid fuels
thereby providing two or more fuel products.

2. The process of claim 1, wherein the process for producing syngas from gas-phase hydrocarbon feedstocks is a catalytic steam-reforming process, and wherein the syngas has a H₂/CO ratio in the range of about 2.0-3.3, and wherein the process for producing syngas has a conversion efficiency of better than about 90% at temperatures below about 1700° F., and wherein the catalyst is a steam reforming, structured catalyst.

3. The process of claim 1, wherein the gas-phase hydrocarbon feedstocks comprise normal alkanes, iso-alkanes, olefins, alcohols, ketones, aldehydes and aromatic hydrocarbons.

4. The process of claim 1, wherein the gas-phase hydrocarbon feedstocks comprise one or more of the following: natural gas, flare-gas, natural gas liquids, natural gas emissions from methane hydratedeposits, petroleum refinery and manufacturing process by-products, bio-gas, stranded natural gas, or methane hydrates.

5. The process of claim 1, wherein the gas-phase hydrocarbon feedstocks comprise vaporized liquid by-products from chemical or biochemical processes.

6. The process of claim 5, wherein the vaporized liquid by-product is glycerol from biodiesel production.

7. The process of claim 1, wherein the syngas generator uses an internal combustion engine to convert the gas-phase hydrocarbons to syngas, and therein the syngas has a H₂/CO ratio in the range of about 1.5-2.1, and wherein the process for producing syngas has a conversion efficiency of better than about 85%.

8. The process of claim 1, wherein the process for producing syngas from gas-phase hydrocarbon feedstocks is a non-catalytic steam-reforming process, and wherein the syngas has a H₂/CO ratio in the range of about 2.0-3.3, and wherein the process for producing syngas has a conversion efficiency of better than about 90% at temperatures below about 2,300° F.

9. The process of claim 1, wherein the process for producing syngas from gas-phase hydrocarbon feedstocks is a partial-oxidation process, and wherein the syngas has a H₂/CO ratio in the range of about 1.0-2.0, and wherein the process for producing syngas has a conversion efficiency of better than about 90% at temperatures below about 2,300° F.

10. The process of claim 1, wherein there are conditions in the catalytic reactor for the production of liquid fuels, and wherein the conditions are changed in order to shift the product slate heavier.

11. The process of claim 9, wherein the syngas has a H₂/CO ratio of less than about 2.0.

12. The process of claim 1, wherein the syngas is subjected to a purification process before it is converted into premium fuels, and wherein the purification process is a solid-phase process, and wherein the process reduces sulfur compounds and hydrogen cyanide in the syngas to less than 20 ppb and reduces ammonia in the syngas to less than 5 ppm.

13. The process of claim 12, wherein the ammonia in the syngas is reduced to less than 500 ppb.

14. The process of claim 1, wherein the catalytic reactor comprises three or more catalytic reactors connected in series.

15. The process of claim 1, wherein the catalytic reactor converts more than about 85 volume % of the CO in the syngas directly into hydrocarbon products without requiring tailgas compress and recycling to the catalytic reactors.

16. The process of claim 1, wherein the catalyst comprises an alumina substrate, and wherein the alumina substrate has a surface, and wherein the surface pH is approximately neutral.

17. The process of claim 16, wherein the catalytic reactor is operated under conditions of temperature, pressure and space velocity such that greater than about 25% of the CO in the syngas is converted to fuels in a first horizontal or vertical reactor and the primary remaining CO is transferred to a second horizontal or vertical reactor, and wherein greater than about 40% of the remaining CO in the second horizontal or vertical reactor is converted to fuels and secondary remaining CO, and wherein the secondary remaining CO is transferred to a third horizontal or vertical reactor, and wherein greater than about 55% of the secondary remaining CO is converted to fuels.

18. The process of claim 16, wherein the liquid fuels demonstrate ASTM D130 copper strip corrosion ratings of 1a.

19. The process of claim 16, wherein in addition to liquid fuels and catalyst reaction water, wax is produced in the catalytic reactor, and wherein the produced wax is less than 5 weight % of the combination of liquid fuels and wax.

20. The process of claim 1, wherein the catalyst reaction water contains hydroxy-alkanes (e.g. alcohols), and wherein the hydroxy-alkanes are present in the catalyst reaction water in a volume % ranging from about 1.00 to about 2.50.

21. The process of claim 1, wherein the catalyst reaction water contains less than about 25 ppm of each C₁ to C₁₀ carboxylic acid (detection limit of 25 ppm for each acid) and these acids are not detected as a total group when using the ASTM D130 copper strip corrosion test.

22. The process of claim 1, wherein the recycled catalyst reaction water is used to adjust the water to carbon mass ratio in the syngas generator to between about 1.5/1.0 and 3.0/1.0.

23. The process of claim 20, wherein a first part of the catalyst reaction water is recycled, and wherein a second part of the catalyst reaction water is injected into oil wells for increasing the production of additional oil.

24. The process of claim 1, wherein the two or more fuel products are distributed to local markets.

25. The process of claim 16, wherein the catalytic reactor is operated under conditions of temperature, pressure and space velocity, and wherein the conditions of the catalytic reactor are changed to shift the product slate heavier, and wherein the pressure is greater than about 350 psig.

26. The process of claim 16, wherein the catalytic reactor is operated under conditions of temperature, pressure and space velocity, and wherein the conditions of the catalytic reactor are changed to shift the product distribution to a higher molecular weight, and wherein the temperature is greater than about 420° F.

27. The process of claim 16, wherein the catalytic reactor is operated under conditions of temperature, pressure and space velocity, and wherein the conditions of the catalytic reactor are changed to shift the product distribution to a higher molecular weight, and wherein the gas hourly space velocity is less than about 2000 hr⁻¹.

28. The process of claim 16, wherein the catalytic reactor is operated under conditions of temperature, pressure and space velocity, and wherein the conditions of the catalytic reactor are change to shift the product distribution to a higher molecular weight, and wherein the pressure is greater than about 350 psi.
